(19) United States
(12) Patent Application Publication
(10) Pub. No.: US 2008/0035806 A1
(43) Pub. Date: Feb. 14, 2008

(54) Adjustable leveling radar mounting tower

(76) Inventors: Robert A. Sporay, Middletown, DE (US); Charles Kaczmarczyk, Middletown, DE (US)

Correspondence Address: SUNG I. OH, PROFESSIONAL LAW CORPORATION, 710 QUAIL VALLEY LANE, WEST COVINA, CA, 91791, US

(21) Appl. No.: 11/500,778

(22) Filed: Aug. 8, 2006

(51) Int. Cl. F16M 11/00

(52) U.S. Cl. 248/161

(57) ABSTRACT

An adjustable and leveling radar mounting tower for use on a marine vessel. The mounting tower is capable of being adjusted to different angles and is capable of being raised and lowered as well.

### TECHNICAL FIELD OF THE INVENTION

The present invention relates to the general art of marine vessels, and to the particular field of accessories for use with marine vessels.

### BACKGROUND OF THE INVENTION

Boats, and particularly pleasure craft, are frequently fitted with a multitude of antennas for a variety of purposes. For example, a single vessel may have antennas for CB, VHF, UHF, TV, AM/FM, cell phone, Orbcomm™ communications, satellite phone, SSB, GPS, and/or a multiband antenna, all in addition to radar. Each antenna has unique design constraints for optimum performance, but one feature common to all is a requirement to receive or transmit at one or more resonant frequencies.

For a long time, marine radio systems have been in wide use on pleasure craft type boats such as cabin cruisers and like water craft having superstructures which extend above the normal deck level. The antennas for such marine radios are usually in the form of elongated antenna devices of considerable height which, if provision is not made to lower or depress them in some manner, create problems when the boat passes under low obstructions such as bridges or into docking bays of boat houses and the like. Commonly the elongated whiplike marine radio antennas can be made sufficiently movable by providing flexible springlike mounts or some kind of pivotal connection at their lower mounted ends to retract them from their normal elevated positions. Marine radar systems have now become more widely used for private pleasure watercraft such as cabin cruisers and the like, and typically involve a rotary radiation beam emitting and receiving antenna element and mounting structure, for the common PPI type radar unit display, which is a relatively rigid structure and projects usually several feet above the mounting base for the radar antenna. Clearly such structures may create considerable problems in providing sufficient clearance in the upper part of the boat or watercraft to pass under low obstructions.

The inventor is aware of various mounting devices for radar antennae for use on or with marine vessels. Some mounting devices fix the position of the radar antenna and do not facilitate any pivotal movement to compensate for boat movement. More commonly, the radar mounts known to the inventor have included some type of self-leveling mechanism which allows the mounted radar antenna to swing freely and, thus, naturally assume a horizontal position. Some self-leveling mounts have further included dampening means to prevent the uncontrolled swinging and constant searching for horizontal generally associated with undampened types of the devices.

Therefore, there is a need for a mount for a radar tower on a marine vessel which can be adjusted but which will be stable and secure.

### SUMMARY OF THE INVENTION

The above-discussed disadvantages of the prior art are overcome by an adjustable and leveling radar mounting tower which is capable of being adjusted to different angles and capable of being raised and lowered as well.

Using the device embodying the present invention will permit radar equipment to be mounted and angled to its most effective position on all cabin roofs of marine vessels, no matter what the angle of the roof and no matter how or at what angle the vessel rides in the water. The device of the present invention also permits the vessel to travel under low overpasses, such as bridges and traffic lights.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a radar mounting tower embodying the present invention.

FIG. 2 is a side elevational view of the radar mounting tower of the present invention.

FIG. 3 is a front elevational view of the radar mounting tower of the present invention.

FIG. 4 shows a bolt that is used in the radar mounting tower of the present invention.

### DETAILED DESCRIPTION OF THE INVENTION

Referring to the figures, it can be understood that the present invention is embodied in a mount 10 for adjustably mounting radar equipment 12 on a marine vessel 14 in a manner which easily accommodates different angular orientations of the vessel or the element on which the radar equipment is mounted. Mount 10 comprises a first plate 20 that is a base plate when in use. First plate 20 includes a plurality of mounting holes, such as mounting hole 22, defined therethrough through which fasteners, such as screws or the like, extend to mount plate 20 on vessel 14.

A second plate 26 is a radar unit mounting plate when in use. Second plate 26 includes a first surface 28 which is a top surface when the second plate is in use and a second surface 30 which is a bottom surface when the second plate is in use. A plurality of mounting holes, such as hole 32, are defined therethrough through which fasteners, such as mounting screws or the like, are accommodated.

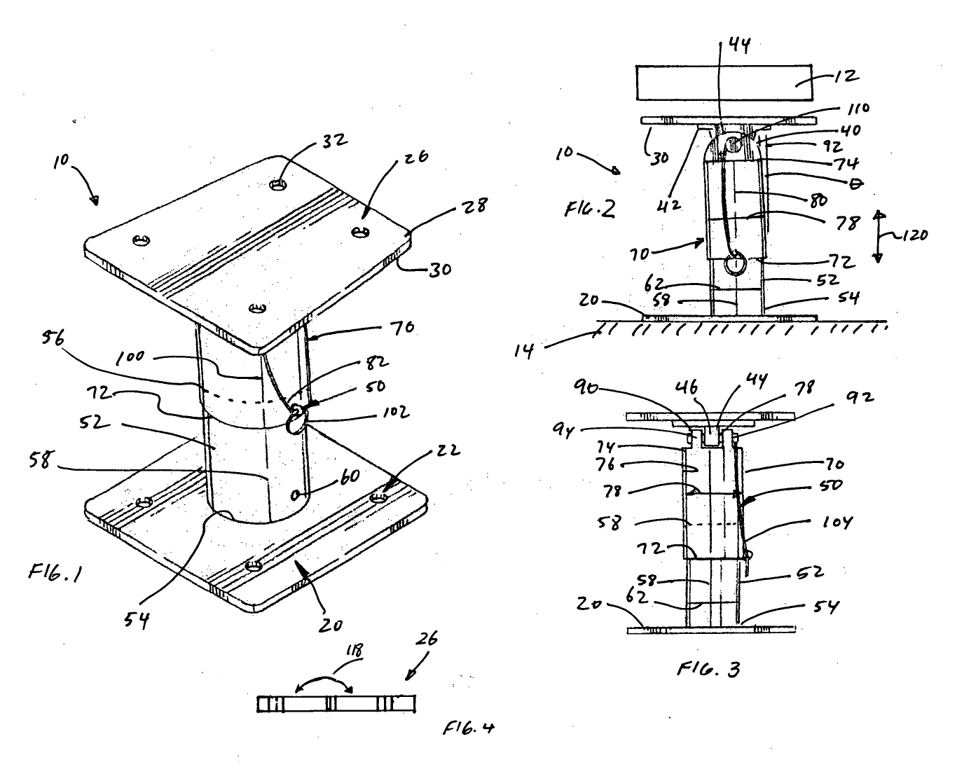

A support post mounting unit 40 is located on second surface 30 of the second plate. Support post mounting unit 40 has a mounting plate 42 fixedly mounted on second surface 30. A supporting element 44 is mounted on mounting plate 42. A support post 50 connects second plate 26 to first plate 20. Support post 50 includes a first tubular element 52 which has a first end 54 fixedly mounted on first plate 20 and extends upward therefrom in the use orientation shown in FIG. 1. A second end 56 of element 52 is spaced apart from first plate 20, and a longitudinal axis 58 extends between first end 54 and second end 56 of the first tubular element.

A plurality of set pin receiving holes, such as hole 60, are defined through the first tubular element. The set pin receiving holes of the first tubular element are spaced apart from each other in the direction of longitudinal axis 58. First tubular element has an external dimension 62. A second tubular element 70 has a first end 72 and a second end 74. Second end 74 is located adjacent to mounting plate 42. A bore 76 is defined through element 72 from first end 72 to second end 74. Bore 76 defined through the second tubular element has an internal dimension 78. A longitudinal axis 80 extends between first end 72 and second end 74 of the second tubular element.

A plurality of set pin receiving holes, such as hole 82, are defined through the second tubular element. The set pin receiving holes of the second tubular element are spaced apart from each other in the direction of longitudinal axis 80 of the second tubular element. Internal dimension 78 of bore 76 of second tubular element 70 is larger than external dimension 62 of first tubular element 52 so the first tubular element is telescopingly received in the second tubular element. This will permit adjustment of the spacing between plates 20 and 26. The set pin receiving holes 82 of the second tubular element are alignable with the set pin receiving holes 60 of the first tubular element.

Two shoulders 90 and 92 are mounted on second end 74 of the second tubular element. Each shoulder has a bolt receiving hole 94 defined therethough. The bolt receiving holes of the shoulders are aligned with each other and with the supporting element 44 mounted on the mounting plate. A set pin unit 100 includes a set pin 102 which is received in the set pin receiving holes of the first and second tubular elements to lock the first and second tubular elements together and a lanyard 104 connecting the set pin to one of the two shoulders 90 and 92.

A bolt 110 is accommodated in the aligned bolt receiving holes. Bolt 110 is tightened to tighten mounting unit 40 to supporting element 44. As indicated by double-headed arrow 118 in FIG. 4, second plate 26 is movable in the aligned bolt receiving holes between a first position and a second position.

The angular orientation of second plate 26 with respect to vertical is indicated in FIG. 2 by angle θ, and this orientation can be altered when the bolt is disengaged, and then set and tightened. In this manner, odd angles of either the vessel or the element of the vessel can be accommodated by mount 10. As indicated by double-headed arrow 120 the set pin is used to adjust the spacing between plates 20 and 26 to further adjust the position of the radar dish on the marine vessel.

Use of mount 10 can be understood from the teaching of the foregoing disclosure and thus will be only briefly discussed. Mount 10 is fixed to a portion of a marine vehicle, such as a cabin roof or the like, and a radar dish is mounted on the mount. The angular orientation and spacing of plates 20 and 26 with respect to each other is adjusted using the mount and the mount is secured using the set pin and the tightened bolt 110.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A mount for adjustably mounting radar equipment on a marine vessel comprising:
A) a first plate that is a base plate when in use, the first plate including a plurality of mounting holes defined therethrough;
B) a second plate which is a radar unit mounting plate when in use, the second plate including
(1) a first surface which is a top surface when the second plate is in use,
(2) a second surface which is a bottom surface when the second plate is in use,
(3) a plurality of mounting holes defined therethrough, and
(4) a support post mounting unit on the second surface of the second plate, the support post mounting unit having
(a) a mounting plate fixedly mounted on the second surface of the second plate, and
(b) a supporting element mounted on the mounting plate, the supporting element including a bore defined therethrough;
C) a support post connecting the second plate to the first plate, the support post including
(1) a first tubular element having
(a) a first end fixedly mounted on the first plate,
(b) a second end which is spaced apart from the first plate,
(c) a longitudinal axis which extends between the first end of the first tubular element and the second end of the first tubular element,
(d) a plurality of set pin receiving holes defined through the first tubular element, the set pin receiving holes of the first tubular element being spaced apart from each other in the direction of the longitudinal axis of the first tubular element,
(e) the first tubular element having an external dimension,
(2) a second tubular element having
(a) a first end,
(b) a second end, the second end of the second tubular element being located adjacent to the mounting plate,
(c) a bore defined therethrough, the bore defined through the second tubular element having an internal dimension,
(d) a longitudinal axis which extends between the first end of the second tubular element and the second end of the second tubular element,
(e) a plurality of set pin receiving holes defined through the second tubular element, the set pin receiving holes of the second tubular element being spaced apart from each other in the direction of the longitudinal axis of the second tubular element,
(f) the internal dimension of the bore of the second tubular element being larger than the external dimension of the first tubular element,
(g) the first tubular element being telescopingly received in the second tubular element,
(h) the set pin receiving holes of the second tubular element being alignable with the set pin receiving holes of the first tubular element, and
(i) two shoulders mounted on second end of the second tubular element, each shoulder having a bolt receiving hole defined therethough, the bolt receiving holes of the shoulders being aligned with each other and with the supporting element mounted on the mounting plate;
D) a set pin unit which includes
(1) a set pin which is received in the set pin receiving holes of the first and second tubular elements to lock the first and second tubular elements together, and
(2) a lanyard connecting the set pin to one of the two shoulders;
E) a bolt which is accommodated in the aligned bolt receiving holes, the bolt being movable in the aligned bolt receiving holes between a first position and a second position and being tightenable to lock the shoulders to the supporting element; and
F) a radar dish mounted on the second plate, and a marine vessel on which the first plate is mounted.

2. A mount for adjustably mounting radar equipment on a marine vessel comprising:
A) a first plate that is a base plate when in use;
B) a second plate which is a radar unit mounting plate when in use, the second plate including a support post mounting unit on the second surface of the second plate, the support post mounting unit having a mounting plate fixedly mounted on the second surface of the second plate, and a supporting element mounted on the mounting plate, the supporting element including a bore defined therethrough;
C) a support post connecting the second plate to the first plate, the support post including
(1) a first tubular element having a plurality of set pin receiving holes defined through the first tubular element, the set pin receiving holes of the first tubular element being spaced apart from each other, the first tubular element having an external dimension, and
(2) a second tubular element having a bore defined therethrough, the bore defined through the second tubular element having an internal dimension, a plurality of set pin receiving holes defined through the second tubular element, the set pin receiving holes of the second tubular element being spaced apart from each other, the internal dimension of the bore of the second tubular element being larger than the external dimension of the first tubular element, the first tubular element being telescopingly received in the second tubular element, the set pin receiving holes of the second tubular element being alignable with the set pin receiving holes of the first tubular element, and two shoulders mounted on the second tubular element, each shoulder having a bolt receiving hole defined therethough, the bolt receiving holes of the shoulders being aligned with each other and with the supporting element mounted on the mounting plate;
D) a set pin which is received in the set pin receiving holes of the first and second tubular elements to lock the first and second tubular elements together;
E) a bolt which is accommodated in the aligned bolt receiving holes, the bolt being movable in the aligned bolt receiving holes between a first position and a second position and being tightenable to lock the shoulders to the supporting element; and
F) a radar dish mounted on the second plate, and a marine vessel on which the first plate is mounted.
